(19) United States
(12) Patent Application Publication
(10) Pub. No.: US 2006/0027950 A1
(43) Pub. Date: Feb. 9, 2006

(54) Method for manufacturing soft magnetic material

(75) Inventors: Masahiro Ishitani, Oobu-city (JP); Yoshiaki Nishijima, Toyokawa-city (JP); Yurio Nomura, Nagoya-city (JP); Kouichi Yamaguchi, Kyoto-city (JP); Yuichi Ishikawa, Kyoto-city (JP); Hidekazu Hayama, Kyoto-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/195,848

(22) Filed: Aug. 3, 2005

(30) Foreign Application Priority Data
Aug. 5, 2004 (JP) 2004-229500(PAT.)

(51) Int. Cl. C04B 33/32; C04B 33/36; C04B 35/64

(52) U.S. Cl. 264/613

(57) ABSTRACT

The invention provides a method for manufacturing a soft magnetic material, wherein an Fe—Si alloy powder is heated in a weakly oxidizing atmosphere to form a SiO₂ oxide film on the surface, and the powder is then press-molded and fired in a weakly oxidizing atmosphere to obtain a sintered product. By performing the surface oxidizing step in a weakly oxidizing atmosphere such as water vapor, Si is selectively oxidized to form a thin oxide film with high electrical resistance. Furthermore, by firing the molded product in a weakly oxidizing atmosphere, the sintering can be performed while the oxide film, in which cracks and the like are generated at the press-molding, is repaired.

### BACKGROUND OF THE INVENTION

1. Field of the Invention

The present invention relates to a method for manufacturing a soft magnetic material which can be applied to, for example, the core material of solenoid actuators and transducers. More specifically, the present invention relates to a method for manufacturing a soft magnetic material by firing an iron-based soft magnetic powder in which the surface is covered by an oxide film with high electrical resistance.

2. Description of the Related Art

In order to increase a response speed of a solenoid valve used in the fuel injection system or the like of an internal combustion engine, the soft magnetic material as a core material of an actuator is required to have high saturation magnetic flux density and high magnetic permeability. The soft magnetic material used for such application is generally manufactured by sintering a powder, and the raw material powder used therefor is usually an inexpensive iron-based soft magnetic powder having high saturation magnetic flux density. At this time, in order to obtain a soft magnetic material reduced in loss (iron loss) ascribable to eddy currents, it is necessary to form a grain boundary segregation layer with high electrical resistance in the sintered structure and produce a sintered product with high magnetic permeability and high strength.

In recent years, for the purpose of attaining high magnetic permeability, low iron loss and the like of the soft magnetic material, studies are being made on the technique of manufacturing a soft magnetic material by forming an insulating film on the surface of a soft magnetic powder, press-molding the resulting soft magnetic powder material, and sintering the press-molded product. As for conventional techniques, Japanese Unexamined Patent Publication No. 05-036514 (pages 2, 3 etc.), for example, discloses a composite soft magnetic powder material in which the surface of a mother phase particle comprising an Fe-based magnetic metal is covered with a second substance with high electrical resistance and high magnetic permeability, such as ferrite, and further covered with an insulating film comprising a third substance with high electrical resistance.

In the manufacturing method of Japanese Unexamined Patent Publication No. 05-036514, an atomized Fe-based alloy powder is immersed in an aqueous solution of NiCl₂ and ZnCl₂ to adsorb metal ions and, then, is oxidized in air to cause a ferritizing reaction, whereby a soft magnetic Ni—Zn ferrite thin layer (second substance) is formed on the surface of the powder. Furthermore, sputtering of Al is performed in a nitrogen atmosphere to form an insulating film mainly comprising AlN on the Ni—Zn ferrite thin layer. In this way, a composite magnetic powder having a three-layer structure is prepared. Thereafter, a B₂O₃ powder is added to this composite magnetic powder to obtain a molding material. This molding material is press-molded into a desired shape and the press-molded product is sintered at 1,000° C., by the hot-press method and while applying pressure, whereby a sintered product of the soft magnetic material is produced.

However, in the above-described conventional manufacturing method, the surface of the atomized alloy powder must be covered by multiple different substances and furthermore, the production cost is high, because the step of immersing and thereby oxidizing the atomized alloy powder in a solution to form an Ni—Zn ferrite thin film is repeated, or the step of sputtering Al in a nitrogen atmosphere to form an insulating film takes extra effort. Moreover, in the method of forming an insulating film by covering the surface of the raw material powder with a different substance, such as sputtering of Al, the thickness of the insulating film is liable to be large and it is difficult to uniformly form a thin film at the nanometer-level. As a result, the magnetic material density in the soft magnetic member decreases and in turn, the saturation magnetic flux density decreases, giving rise to deterioration of the magnetic properties.

On the other hand, when the insulting film is formed as a thin film so as to enhance the magnetic properties, cracking may occur in the insulating film on the soft magnetic powder surface due to the pressing pressure during press-molding of the soft magnetic powder. When the insulating film is damaged, the insulating property between soft magnetic powder particles decreases and the iron loss (loss ascribable to eddy currents) in the sintered soft magnetic material disadvantageously increases.

### SUMMARY OF THE INVENTION

The present invention has been made under these circumstances and an object of the present invention is to obtain a sintered product of a soft magnetic material, in which an insulating thin film with high electrical resistance is farmed on the surface of a powder mainly comprising an inexpensive iron and the insulating film is protected from damages such as cracking and which can satisfy all of the requirements of high saturation magnetic flux density, high magnetic permeation, low iron loss, high density and high productivity, to a high level.

In order to attain the above-described object, in the method for manufacturing a soft magnetic powder material of the present invention, an oxide film is formed on the surface of a soft magnetic powder mainly comprising iron (surface oxidizing step), the powder is then press-molded to obtain a molded product in a desired shape (press-molding step), and the molded product is fired in a weakly oxidizing atmosphere created by mixing a weakly oxidizing gas with an inert gas, thereby producing a sintered product of the soft magnetic material (sintering step).

### BRIEF DESCRIPTION OF THE DRAWINGS

FIG. 1 is a view for explaining one example of the process of manufacturing a soft magnetic material according to the method of the present invention.

FIG. 2 is a view for explaining the mechanism of the surface oxidation according to the method of the present invention by showing free energy variation ΔG for the oxidation reaction of Fe and Si.

FIG. 3(a) is a view for explaining the surface oxidizing step of Fe—Si powder according to the method of the present invention.

FIG. 3(b) is a view for explaining the mechanism of the surface oxidation, which is an enlarged view of Fe—Si powder surface.

FIG. 4(a) is a partially enlarged view of FIG. 4(b).

FIG. 4(b) is an entire structural view of an oxide film-producing apparatus for use in the surface oxidizing step of the present invention.

FIG. 5 is a view for explaining the temperature conditions in the first and second steps of the sintering step according to the method of the present invention

FIG. 6 is an entire structural view of a sintering apparatus for use in the sintering step of the present invention.

FIG. 7(a) is a view showing the relationship between the depth of oxide film from the surface layer and the oxide number density when the atmospheric temperature is adjusted to 100% or 50%.

FIG. 7(b) is a view showing the relationship between the atmospheric humidity and the thickness of oxide film formed when the oxide film is formed under different atmospheric humidities.

FIG. 8 is a view for explaining another example of the surface oxidizing step according to the method of the present invention.

### DETAILED DESCRIPTION OF THE INVENTION

In the case of manufacturing a soft magnetic material by sintering a soft magnetic powder having formed an the surface thereof an oxide film, if the oxide film is thin, damage may be caused by the press-molding. According to the method of the present invention, in the process of press-molding and then sintering the powder, a weakly oxidizing gas is supplied, so that the powder surface can be again oxidized to fill the cracks or the like and repair the oxide film. At this time, by creating a weakly oxidizing atmosphere, elements having high oxidation reactivity are selectively oxidized and at the same time, the oxidation rate is appropriately restrained, so that a dense and thin oxide film layer with high electrical resistance can be formed on the surface of the powder.

In this way, through the steps simpler than those used before, the insulating property between soft magnetic powder particles can be ensured, the loss ascribable to eddy currents (iron loss) can be decreased and, at the same time, the magnetic properties can be enhanced with an elevated magnetic material density by virtue of a thin oxide film. Therefore, the requirements of high saturation magnetic flux density, high magnetic permeability, low iron loss, high strength and high productivity all can be satisfied to a high level.

According to the method of the present invention (claim 2), in the surface oxidizing step, a soft magnetic alloy powder mainly comprising iron and containing a second element having oxidation reactivity higher than that of iron is used. This soft magnetic alloy powder's heated in a weakly oxidizing atmosphere created by mixing a weakly oxidizing gas with an inert gas, to oxidize, mainly, the second element in the surface layer part of the powder and form an oxide film of the second element on the surface.

Preferably, a soft magnetic alloy powder containing a second element having high oxidation reactivity is used as the raw material powder and the oxidizing reaction is performed in an weakly oxidizing atmosphere, whereby the oxidation of iron in the surface layer part of the soft magnetic alloy powder is restrained and only the second element, more readily undergoing an oxidizing reaction, is selectively oxidized. Also, the oxidation rate is appropriately restrained and, therefore, a dense and strong insulating thin film in the nanometer-level can be formed on the surface of a high-purity iron-based soft magnetic alloy powder. Even if cracks or the like are generated in this oxide film of the second element at the press-molding step, as described above, these are repaired in the sintering step, so that a sintered product of a powder with a small particle diameter, and in which a dense and thin high-resistance layer is present as the surface layer, can be produced through simple steps.

According to the method of the present invention (claim 3), in the surface oxidizing step, an oxidizing process step of heating a soft magnetic alloy powder mainly comprising iron and containing a second element having oxidation reactivity higher than that of iron in a weakly oxidizing atmosphere created by mixing a weakly oxidizing gas with an inert gas, and a reducing process step of heating the soft magnetic alloy powder in a reducing atmosphere are alternately performed to oxidize mainly the second element in the surface layer part of the powder and form an oxide film of the second element.

Using a soft magnetic alloy powder containing a second element having high oxidation reactivity as the raw material powder, it is also possible to repeat an operation of performing an oxidizing reaction in a weakly oxidizing atmosphere and then performing a reduction reaction in an reducing atmosphere. By repeating the operation, the oxidation of the second element in the surface layer can be accelerated while restraining the progress of oxidation into the inside and a surface oxide film with higher purity and higher electrical resistance can be formed As a result, reduction in the iron loss of the magnetic material and enhancement of the magnetic properties can be more effectively attained.

In the method of the present invention (claim 4), the second element is at least one member selected from substances having an oxidizability higher than that of iron, as represented by Si, Ti, Al and Cr.

These elements are suitable as the raw material of the oxide film, because the Gibbs free energy ΔG of an oxidizing reaction for each of these elements is smaller than that for iron and the oxidizing reaction proceeds readily.

In the method of the present invention (claim 5), the weakly oxidizing gas is water vapor or a dinitrogen monoxide gas.

In the oxidation by water vapor, the oxidizing reaction proceeds together with the reducing reaction of H₂O and therefore, the reaction rate is lower as compared with the reaction in air. In particular, the oxidizing reaction of iron almost reaches an equilibrium state and scarcely proceeds and, therefore, it becomes possible to selectively oxidize only the second element which is more readily oxidizable. The oxidation by a dinitrogen monoxide gas also proceeds under the same reaction mode as the reaction above.

In the method of the present invention (claim 6), the weakly oxidizing gas is water vapor and mixed into the inert gas so that the relative humidity at an ordinary temperature can be higher than 50%.

More specifically, when water vapor is used, the weakly oxidizing atmosphere is easily created. In particular, when the oxidation is performed in an atmosphere at a high humidity exceeding 50%, the above-described effect can be obtained easily.

In the method of the present invention (claim 7), the weakly oxidizing gas is water vapor and is mixed into the inert gas so that the relative humidity at an ordinary temperature can be 70 to 100%.

The oxidation is preferably performed in a water vapor atmosphere at a higher humidity, whereby the number density of oxides of the produced oxide film can be increased and a dense and thin film with high electrical resistance can be formed.

In the method of the present invention (claim 8), the surface oxidizing step is preformed under a temperature of 400 to 600° C.

If the atmospheric temperature is lower than the above-described range, the free energy variation ΔG of an oxidizing reaction system of iron by a weakly oxidizing gas becomes ΔG<0, and the effect of restraining the reaction decreases. If the atmospheric temperature exceeds the above-described range, oxidation of the second element may readily proceed but the properties of the obtained magnetic material may be deteriorated. Within the above-described range, a dense oxide film having high oxide number density and high electrical resistance can be formed.

In the method of the present invention (claim 9), the sintering step is performed under a temperature of 400 to 1,100° C.

The sintering step is performed by elevating the temperature to a temperature which is higher than the temperature where the effect of re-forming the oxide film can be obtained while restraining the reaction of iron by the weakly oxidizing gas, and in which the press-molded product of the soft magnetic powder can be sintered. The sintering temperature varies depending on the raw material powder and in the case of an iron-based soft magnetic powder, the sintering is usually performed at a temperature of preferably about 1,100° C. or less

According to the method of the present invention (claim 10), in the sintering step, the oxide film is first re-formed by contacting the soft magnetic powder with a weakly oxidizing gas under a temperature of 400 to 600° C. (first step), and the soft magnetic powder is then sintered under a temperature of 600 to 1,100° C. (second step).

Preferably, the soft magnetic powder is contacted with a weakly oxidizing gas at a relatively low temperature in the first step, whereby the surface oxide film is repaired and a dense and firm insulating thin film at the nanometer-level is re-formed on the surface of the iron-based soft magnetic alloy powder. Thereafter, the temperature is elevated to the sintering temperature in the second step, whereby a sintered product having high magnetic permeability and high strength and having a grain boundary segregation layer with high electrical resistance is obtained.

In the method of the present invention (claim 11), the soft magnetic powder is an atomized alloy powder having an average particle diameter of 0.01 to 500 μm.

The above-described reduction in the thickness of the surface oxide film allows for use of a soft magnetic powder having a small particle diameter. Therefore, by using an atomized particle with good compressibility and adjusting the particle diameter to be as fine as 0.01 to 500 μm, the strength of the soft magnetic material can be increased and the freedom of forming at the molding can be widened.

### EXAMPLES

The best mode for carrying out the present invention is described below by referring to specific examples.

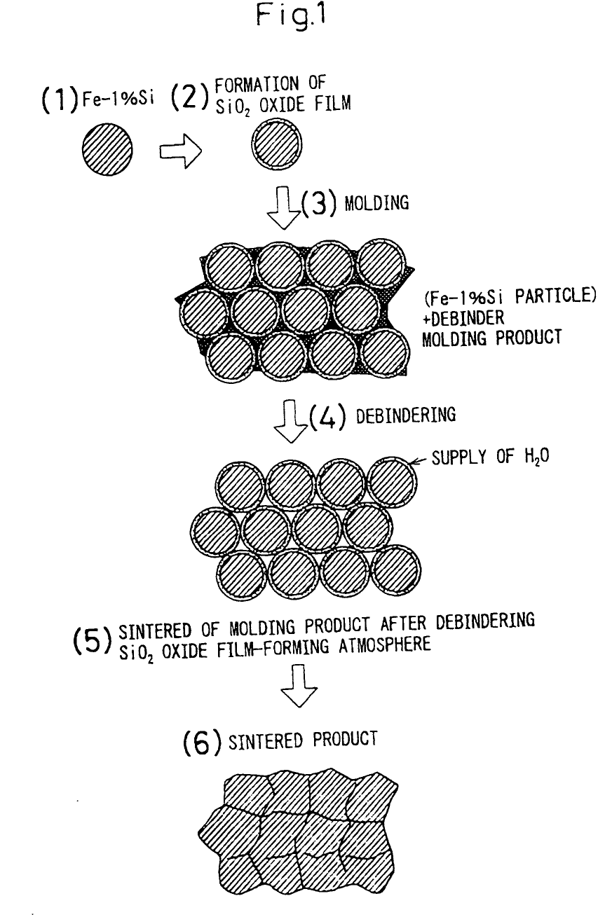

FIG. 1 shows the production process of a soft magnetic material according to the present invention, comprising (1) a step of preparing a soft magnetic alloy powder for use as the raw material, (2) a surface oxidizing step of surface-oxidizing the soft magnetic alloy powder to form an oxide film, (3) a press-molding step of press-molding the soft magnetic alloy powder having formed on the surface thereof an oxide film to obtain a molded product in a desired shape, (4) a debindering step of removing the binder of the press-molded product, and (5) and (6) a sintering step of sintering the debindered molded product to obtain a sintered product of the soft magnetic material.

(1) Step of Preparing Raw Material Powder

In the present invention, the soft magnetic alloy powder used as the raw material is a powder mainly comprising iron (Fe) and containing a second element having oxidation reactivity higher than that of iron. Examples of the second element include Si, Ti, Al and Cr. A powder of an alloy containing at least one element, or two or more elements, selected from these elements, such as Fe—Si alloy, Fe—Ti alloy, Fe—Al alloy, Fe—Cr alloy and Fe—Al—Si alloy, is used. More specifically, an Fe—Si alloy at a compositional ratio of, for example, Fe of 95 to 99.9% and Si of 0.1 to 5%, an Fe—Al alloy at a compositional ratio of, for example, Fe of 92.5 to 97.5% and Al of 2.5 to 7.5%, and an Fe—Al—Si alloy at a compositional ratio of, for example, Fe of 90 to 97%, Al of 3.5 to 6.5% and Si of 0.1 to 5% can be used.

Here, in general, the compositional ratio of Si, Al and the like is determined by taking account of the following three factors (i) to (iii):

(i) the contents of Al, Si and the like are preferably smaller in the light of enhancing the magnetic properties;

(ii) the contents of Al, Si and the like should be within the solid solubility limit where no intermetallic compound is formed; and

(iii) the thickness of the oxide film should be not less than the thickness with which a target value of electrical resistance can be ensured.

For example, in order to enhance the magnetic properties of (i) above, the compositional ratio of these elements is suitably 2% or less, preferably 1% or less. From this range, a minimum compositional ratio allowing for formation of a satisfactory oxide film may be selected. In FIG. 1, an alloy powder (Fe-1% Si) obtained by incorporating only Si into Fe is shown. Incidentally, two or more of the soft magnetic alloy powders described above may be mixed and used.

The soft magnetic alloy powder used as the raw material is preferably an atomized particle prepared by an atomization method of powdering a molten alloy with use of an atomizing medium such as water and an inert gas. The atomized alloy powder has high purity and good compressibility and therefore, a soft magnetic material having high density and good magnetic properties can be realized. The average particle diameter of the soft magnetic alloy powder is generally 500 μm or less, preferably from 100 to 200 μm. The soft magnetic alloy powder is pulverized by a pulverizing apparatus (attritor) to have a desired average particle diameter. In this pulverizing step, a highly active fracture surface is formed on the surface of the soft magnetic alloy powder. In order to facilitate the pulverization, a material before being annealed is used as the raw material for the manufacture of the soft magnetic alloy powder. During the pulverization, the stainless steel container for pulverization is preferably water-cooled so as to prevent the temperature of the soft magnetic alloy powder from rising due to the pulverization heat.

For obtaining the soft magnetic alloy powder as the raw material, either the atomized powder prepared by the atomization method or the powder particles pulverized by using a pulverizing apparatus (attritor) may be used alone.

(2) Surface Oxidizing Step

Subsequently, an oxide film is formed on the surface of the soft magnetic alloy powder as the raw material. This surface oxidizing step is performed in a weakly oxidizing atmosphere created by mixing a weakly oxidizing gas with an inert gas and, in this step, the soft magnetic alloy powder is heated at a high temperature to mainly oxidize the second element in the surface layer part. Suitable examples of the inert gas include a nitrogen gas (N₂), and suitable examples of the weakly oxidizing gas include water vapor (H₂O). By creating a weakly oxidizing atmosphere, oxidation of Fe is restrained and the second element, which is more readily oxidizable, is selectively oxidized, whereby an oxide film of the second element can be formed. In the case where the Fe—Si alloy powder shown in FIG. 1 is oxidized by water vapor (H₂O), Si as the second element is selectively oxidized on the powder surface and, as a result, an SiO₂ film with high electrical resistance covering the powder surface is formed to a small thickness of, for example, a few nm.

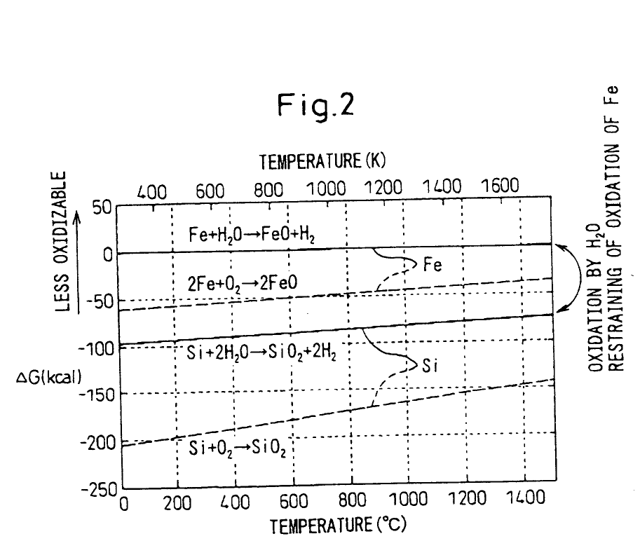

Here, the mechanism of surface oxidation of the Fe—Si alloy powder in a weakly oxidizing atmosphere is described. FIG. 2 shows the oxidation reactivity of Fe and the oxidation reactivity of Si in an oxygen (O₂) atmosphere and in a water vapor (H₂O) atmosphere by comparing them with each other. The oxidizing reaction of Fe or Si in each atmosphere is expressed by the following formulae.

In the case of oxidation by oxygen (O₂):
2Fe+O₂→2FeO (formula 1)
Si+O₂→SiO₂ (formula 2)

In the case of oxidation by water vapor (H₂O)
Fe+H₂O→FeO+H₂ (formula 3)
Si+2H₂O→SiO₂+H₂ (formula 4)

In FIG. 2, the ordinate specifies the Gibbs free energy variation ΔG in each reaction system. As the ΔG is larger, less oxidation occurs. FIG. 2 shows that the oxidation of Fe occurs less as compared with Si, and the oxidizing reaction with water vapor (H₂O) (formulae 3 and 4) is more difficult to proceed than the oxidizing reaction by oxygen (O₂) (formulae 1 and 2). In the oxidation by oxygen (O₂), in both cases, of Fe and Si, the free energy after the reaction is lower than the free energy before the reaction, and the system is in a more stable state. In other words, the Gibbs free energy ΔG is minus for both cases, and both the reactions of Formulae 1 and 2 proceed, though Si having a large absolute value of ΔG is more readily oxidizable.

On the other hand, in the oxidation by water vapor (H₂O), in both the cases of Fe and Si, an absolute value of the Gibbs free energy ΔG is lower than in the oxidation by oxygen (O₂). Particularly, the Gibbs free energy ΔG of Fe before and after the reaction becomes nearly 0 and therefore, the reaction of formula 3 scarcely proceeds and only the reaction of formula 4 proceeds.

Accordingly, in the case of oxidation by water vapor (H₂O), an SiO₂ oxide film can be selectively formed while restraining the oxidation of Fe. As shown in FIG. 2, in the oxidation of Fe by water vapor (H₂O), the Gibbs free energy ΔG is in the vicinity of 0 in the entire temperature range. Particularly, in the temperature range of about 400° C. or more, the Gibbs free energy ΔG becomes nearly 0 and the effect of restraining the oxidation of Fe increases. In the oxidation of Si by water vapor (H₂O), a reducing reaction of H₂O simultaneously proceeds and therefore, the reaction proceeds with more difficultly than in an oxygen (O₂) atmosphere, allowing for proceeding of oxidation at an appropriate speed. As a result, the oxidation does not proceed into the inside, so that the magnetic material density can be kept high, and the SiO₂ oxide film can be uniformly formed at a high density in the surface layer part of the powder to give a dense and thin film, on the order of several nm, with high electrical resistance.

In this way, the weakly oxidizing gas is preferably a gas of an oxygen compound, which allows for progress of a reducing reaction simultaneously with the oxidation reaction. As for the gas taking the same reaction mode, for example, even when a dinitrogen monoxide (N₂O) is used, the same effects can be obtained.

In the case where the weakly oxidizing gas is water vapor (H₂O), the relative humidity at an ordinary temperature is preferably adjusted to be higher than 50% at the time of mixing the water vapor into the atmosphere. In general, as the atmospheric humidity becomes higher, the thickness of the formed oxide film becomes larger. Under the low humidity condition, the oxide film does not grow satisfactorily. As the humidity becomes higher, the oxidizing reaction of the second element such as Si and Al in the surface layer part of the powder is more promoted and the oxide number density in the oxide film becomes higher, whereby a dense insulating oxide film with high electrical resistance is obtained. Preferably, the water vapor is mixed to give a high humidity of 70 to 100% (relative humidity) at an ordinary temperature. When the atmospheric humidity is in the vicinity of 100%, an oxide film having a high oxide number density and a sufficient thickness is obtained and the objective electrical resistance can be ensured.

As for the heating means in the surface oxidizing step, a general heating furnace such as electric furnace is used. For example, in the case of forming an oxide film in an electric furnace, the thickness of the oxide film may be adjusted by controlling the atmospheric temperature (heating temperature), heating time and contents of Si and Al in the soft magnetic alloy powder. Usually, the atmospheric temperature may be appropriately set in the range of 400 to 900° C. By setting the atmospheric temperature to 400° C. or more, the Gibbs free energy ΔG for the oxidizing reaction of iron can be made close to 0, and an effect of restraining the oxidation of iron can be obtained. When the atmospheric temperature is elevated, the formation of oxide film readily proceeds, but the properties of the obtained magnetic material may be deteriorated. Therefore, the atmospheric temperature is suitably 900° C. or lower. The atmospheric temperature is preferably from 400 to 600° C.

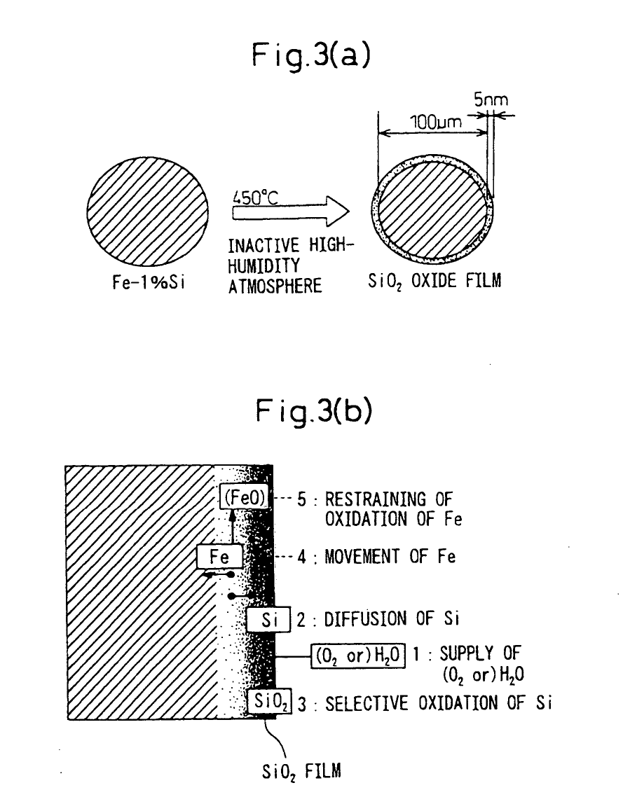

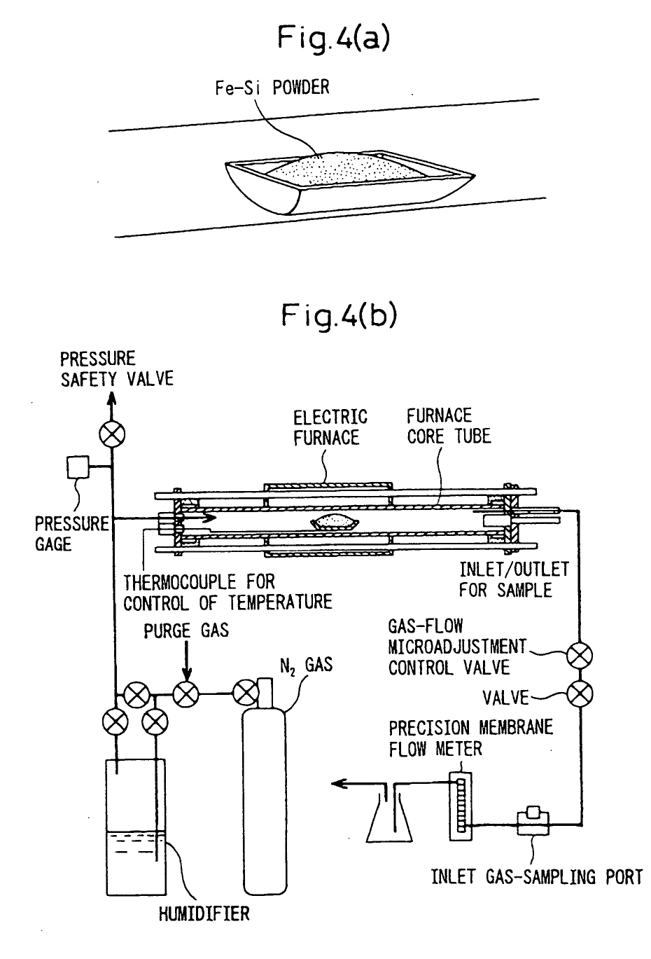

FIGS. 3(a), 3(b), 4(a), and 4(b) show one example of the surface oxidation of the soft magnetic alloy powder by the above-described method. As shown in FIG. 3(a), an atomized Fe-1% Si alloy particle prepared to have an average particle diameter of about 100 μm is used as the raw material powder and heated in an inactive high-humidity atmosphere to effect surface oxidation. FIG. 4(b) is an oxide film-producing apparatus used here, in which a container housing the raw material powder is placed (see, FIG. 4(a) at the center of the furnace core tube positioned in an electric furnace, an atmospheric gas adjusted to a relative humidity of 100% (ordinary temperature) by mixing water vapor (H₂O) into a nitrogen (N₂) gas through a humidifier is introduced into the furnace core tube at a predetermined flow rate. The inside of the electric furnace is heated at a temperature of 450° C. by using a thermocouple for the control of temperature to allow the oxidizing reaction to proceed for 2 hours, as a result, an SiO₂ oxide film with a thickness of 5 nm is formed on the surface of the Fe-1% Si alloy powder.

FIG. 3(b) shows a situation of forming the oxide film in the surface layer part of the atomized Fe-1% Si alloy powder. As shown by 1 to 3 in the Figure, when water vapor (H₂O) is supplied to the powder surface by the above-described apparatus in place of oxygen (O₂), a reaction between Si, which is more readily oxidizable than Fe, and H₂O proceeds in the surface layer part of the powder as described above. Then, the Si concentration on the surface decreases and therefore, S diffuses from the inside to the surface, reacts with H₂O and is selectively oxidized. On the other hand, as shown by 4 and 5 in the Figure, Fe of which the concentration becomes relatively high moves as if it is pushed inside, and the oxidation of Fe is restrained. As a result, the surface of the Fe-1% Si alloy powder is uniformly covered with an SiO₂ oxide film.

Also, unlike the oxidation by oxygen (O₂), when the Fe—Si alloy powder is oxidized by water vapor (H₂O), as described above, the oxidation reaction of Si and the production reaction of H₂ due to reduction of H₂O proceed simultaneously on the powder surface. Under such conditions, the oxidation rate is appropriately restrained and the progress of oxidation into the inside is inhibited, so that an SiO₂ oxide film can be selectively formed at a high density. Accordingly, even when the oxide film is a thin film of about 5 nm as in Example of FIG. 3(a), high electrical resistance can be realized.

In this way, by performing the surface oxidation in an inactive high-temperature atmosphere, a dense insulating thin firm in the nanometer level with high electrical resistance can be formed in the surface layer part of the soft magnetic alloy powder.

(3) Press-Molding Step

After an SiO₂ oxide film is formed on the surface in FIG. 1, the soft magnetic alloy powder is then subjected to the press-molding step. In this step, a binder and a solvent are blended with the soft magnetic alloy powder having formed thereon a surface oxide film, and thoroughly kneaded to produce a molding material. As the binder, for example, a camphor having high tackiness and high slipping property is used so as to obtain a high density. As the solvent, an organic solvent such as acetone may be used. This molding material of the soft magnetic alloy powder is injected into a molding tool and compression-molded under an applied pressure to obtain a molded product in a desired shape. The pressing pressure may be, for example, about 980 Pa (10 ton/cm²). The soft magnetic alloy powder having formed thereon a surface oxide film may also be subjected as is to compression-molding under an applied pressure.

(4) Debindering Step

The molded product obtained in the press-molding step is, as shown in FIG. 1, in the state that Fe-1% Si particles each having an oxide film on the surface are bonded by a binder, and the binder and the like are preferably removed before the sintering step. More specifically, the press-molded product of the soft magnetic alloy powder is heated, for example, in an electric furnace, thereby vaporizing and removing the binder and the solvent. The heating temperature is preferably, for example, on the order of 50 to 100° C.

(5) Sintering Step (First Step)

The molded product, after debindering, is fired to obtain a sintered product of the soft magnetic material. However, the SiO₂ oxide film formed on the surface of the soft magnetic alloy powder in the surface oxidizing step is as thin as several nm and moreover, is vitreous and fragile and therefore, cracking and the like may be generated due to the pressure in the press-molding step. Accordingly, in the present invention, the sintering step is performed in a weakly oxidizing atmosphere and thereby, the cracks and the like generated in the surface oxide film are repaired. More specifically, in the first step, the molded product of the soft magnetic alloy powder is heated in a weakly oxidizing atmosphere created by mixing a weakly oxidizing gas into an inert gas. Suitable examples of the inert gas include nitrogen (N₂) gas, and suitable examples of the weakly oxidizing gas include water vapor (H₂O) and dinitrogen monoxide (N₂O) gas. By supplying water vapor (H₂O) or the like to the surface of the soft magnetic alloy powder, an SiO₂ oxide film-forming atmosphere is again created.

As for the heating means, a general heating furnace such as electric furnace is used. The atmospheric temperature may be, similarly to the surface oxidizing step, appropriately set in the range of 400 to 600° C. By setting the atmospheric temperature to 400° C. or more, the Gibbs free energy ΔG for the oxidizing reaction of iron can be made close to 0, and an effect of re-forming the oxide film while restraining the oxidation of iron can be obtained. If the atmospheric temperature exceeds 600° C., the sintering may proceed without satisfactorily repairing the oxide film. The atmospheric temperature is preferably set to 450 to 550° C. and maintained for a predetermined time, whereby the surface of the soft magnetic alloy powder can be again covered with a firm electrically insulating thin film.

In the case where the weakly oxidizing gas is water vapor (H₂O), the relative humidity at an ordinary temperature is preferably adjusted to be higher than 50% at the time of mixing the water vapor into the atmosphere. In general, as the atmospheric humidity is higher, the oxidation reaction more readily proceeds, whereas if the humidity is low, the oxidation reaction does not proceed. Therefore, the water vapor is preferably mixed to give a high humidity of 70 to 100% (relative humidity) at an ordinary temperature.

Similarly to the surface oxidizing step, as the humidity is higher, the oxidation reaction of the second element such as Si and Al is promoted at the end of the crack in the surface oxide film and the repairing effect becomes higher. Furthermore, the oxide number density in the re-formed oxide film is increased and a dense insulating oxide film with high electrical resistance is obtained. When the atmospheric humidity is in the vicinity of 100%, an oxide film having a high oxide number density and a sufficient thickness is obtained and the objective electrical resistance can be ensured.

(6) Sintering Step (Second Step)

The molded product after debindering, in which the surface oxide film is re-formed, is then heated to a temperature of, for example, 600 to 1,100° C. and held in a weakly oxidizing atmosphere for a predetermined time to obtain a sintered product of the soft magnetic material. The second step is not necessarily performed in an weakly oxidizing atmosphere but considering the effect of heat on the film, the atmosphere is preferably made to be weakly oxidizing. By performing the second step in a weakly oxidizing atmosphere, heat is applied in the atmosphere capable of always re-forming the film, so that one-sided film rupture can be avoided.

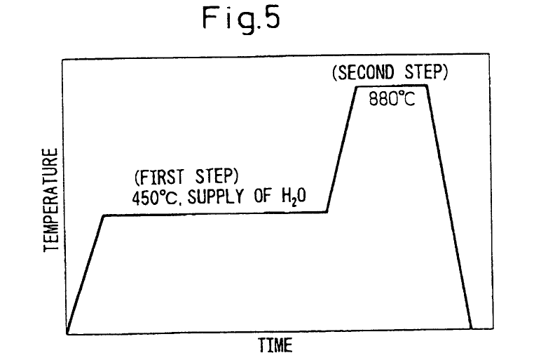

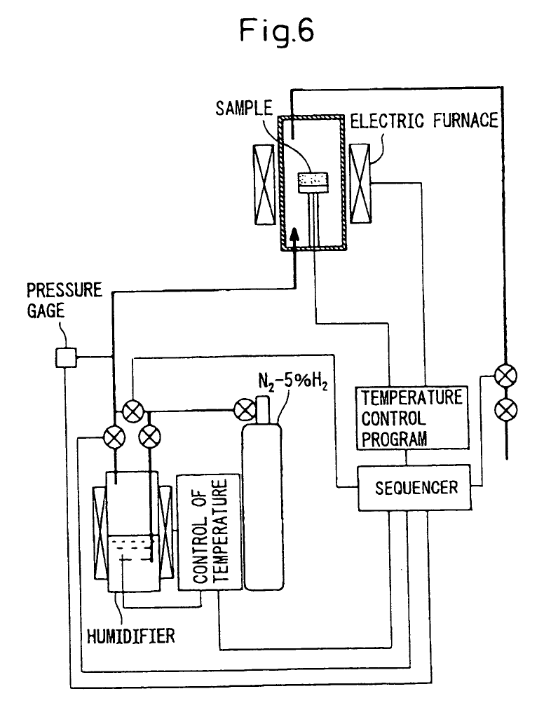

FIGS. 5 and 6 show one example of the sintering step of the soft magnetic alloy powder by the above-described method. A molded product of an Fe-1% Si Alloy powder surface-oxidized in the step of FIG. 3(a) is used as the sample for sintering and fixed on the table in the electric furnace of a sintering apparatus shown in FIG. 6. An atmospheric gas adjusted to a relative humidity of 100% (ordinary temperature) by mixing water vapor (H₂O) into a nitrogen (N₂)-5% hydrogen (H₂) mixed gas through a humidifier is introduced into the electric furnace and heated to a predetermined temperature. At this time, as shown in FIG. 5, the temperature inside the electric furnace is elevated to 450° C. and kept for a predetermined time to effect an oxidation reaction in the first step, and the temperature is further elevated to 880° C. and kept for a predetermined time in the second step. Thereafter, annealing is performed while gradually lowering the temperature, whereby a molded product, through a series of sintering steps, is ensured.

In this way, according to the method of the present invention, the surface oxide film of the Fe—Si alloy powder is repaired in the sintering step and the surface of the powder can be again covered with a firm electrically insulating thin film in the nanometer level. Accordingly, a sintered product of a soft magnetic alloy powder mainly comprising an inexpensive Fe and having low iron loss, in which a dense insulating film with high resistance is formed, is obtained. Furthermore, even when the SiO₂ oxide film formed in the surface oxidizing step is as thin as about 5 nm, a sufficiently high insulating property can be ensured, so that the magnetic material density in the soft magnetic material can be elevated, high saturation flux density and high magnetic permeability can be realized, and the magnetic properties can be enhanced. Moreover, the thinning of the oxide film allows for use of a soft magnetic powder having a small particle diameter and, for example, by adjusting the average particle diameter to be as fine as 0.01 to 10 μm, as apparent from the following Hall-Petch Law, the strength can be increased.
Hall-Petch Law: σy=σ0+k·d^{1/2}
wherein σy is a yield stress, k is a constant, d is a particle diameter of soft magnetic powder, and σ0 is an initial stress.

Furthermore, the manufacturing process is simple, and the productivity is also excellent. The sintered product of the soft magnetic material obtained in this way is useful as various soft magnetic components such as solenoid valve of an internal combustion engine and a core material of a transducer.

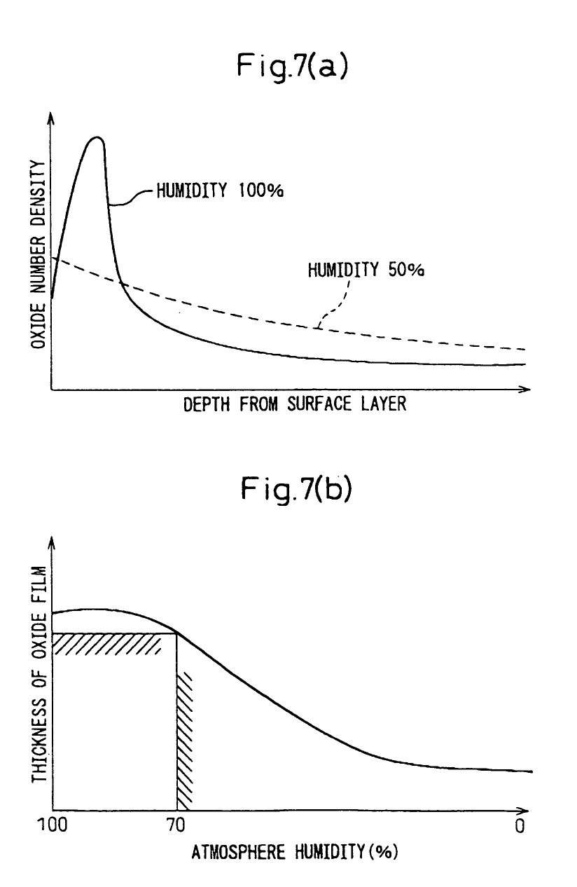

FIG. 7(a) shows the depth of the surface oxide film from the surface layer and the oxide number density when the relative humidity at an ordinary temperature is adjusted to 100% or 50% in an atmosphere resulting from mixing water vapor into an inert gas, by comparing each other. As shown in the Figure, under the condition of relative humidity of 50%, the oxide number density on the surface is decreased to fail to form a good oxide film and moreover, the oxidation proceeds into the inside, revealing that the humidity has a great effect on the formation of the surface oxide film. In general, the atmospheric temperature and the thickness of oxide film formed are in the relationship shown in FIG. 7(b), and the oxide film does not satisfactorily grow under the low humidity condition. When the atmospheric humidity is about 70% or more, an oxide film having an almost satisfactory thickness can be obtained. The atmospheric humidity is preferably near 100% and it is seen that in this case, an oxide film with high oxide number density and high electrical resistance can be realized.

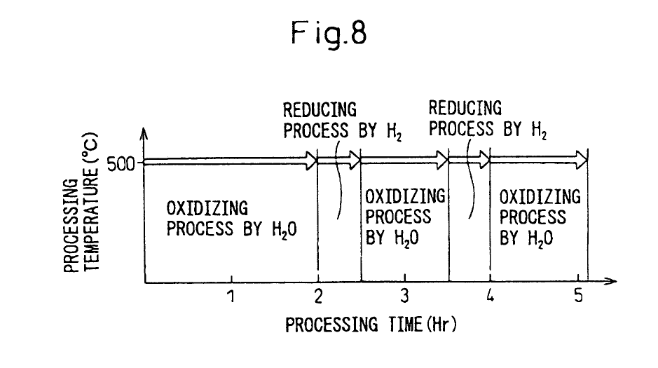

In the production method described above, only a weakly oxidizing atmosphere is employed as the atmosphere in the surface oxidizing step but as shown in FIG. 8, an oxidizing process step in a weakly oxidizing atmosphere created by mixing a weakly oxidizing gas into an inert gas and a reducing process step in a reducing atmosphere may be alternately performed to form the oxide film. In this case, the oxidizing process step is performed in the same manner as above by heating a soft magnetic alloy powder at a high temperature of 400 to 900° C., preferably from 450 to 600° C., in a weakly oxidizing atmosphere created by mixing a weakly oxidizing gas into an inert gas. Nitrogen (N₂) gas or the like is used as the inert gas and using, for example, water vapor (H₂O) as the weakly oxidizing gas, the relative humidity at an ordinary temperature is adjusted to be higher than 50%, preferably from 70 to 100%.

The soft magnetic alloy powder after forming an oxide film on the surface in the oxidizing process step is subsequently heated to a high temperature of 400 to 900° C., preferably from 450 to 600° C., in a reducing atmosphere to effect a reducing process. Suitable examples of the reducing gas include a hydrogen (H₂) gas. In the case of applying a reducing process after the oxidizing process in this way, it is presumed that the surface layer part is exposed to a reducing atmosphere, whereby the oxygen is prevented from diffusing into the inside and the purity can be increased in only the surface layer part.

Accordingly, by repeating the oxidizing process step and the reducing process step, the purity of the oxide film can be elevated, a denser oxide thin film with high electrical resistance can be uniformly formed, and a higher-quality sintered soft magnetic material product can be obtained.

What is claimed is:

1. A method for manufacturing a soft magnetic material, comprising:
a surface oxidizing step of forming an oxide film on the surface of a soft magnetic powder mainly comprising iron,
a press-molding step of obtaining a molded product with a desired shape by press-molding the soft magnetic powder having formed on the surface thereof an oxide film, and
a sintering step of obtaining a sintered product of the soft magnetic material by firing the molded product of said soft magnetic powder in a weakly oxidizing atmosphere created by mixing a weakly oxidizing gas into an inert gas.

2. The method for manufacturing a soft magnetic material according to claim 1 wherein, in said surface oxidizing step, a soft magnetic alloy powder mainly comprising iron and containing a second element having oxidation reactivity higher than that of iron is heated in a weakly oxidizing atmosphere created by mixing a weakly oxidizing gas with an inert gas, to mainly oxidize said second element in the surface layer part of the powder and form an oxide film of said second element on the surface.

3. The method for manufacturing a soft magnetic material according to claim 1 wherein, in said surface oxidizing step, an oxidizing process step of heating a soft magnetic alloy powder mainly comprising iron and containing a second element having oxidation reactivity higher than that of iron in a weakly oxidizing atmosphere created by mixing a weakly oxidizing gas into an inert gas, and a reducing process step of heating the soft magnetic alloy powder in a reducing atmosphere are alternately performed to mainly oxidize said second element in the surface layer part of the powder and form an oxide film of said second element on the surface.

4. The method for manufacturing a soft magnetic material according to claim 2, wherein said second element is at least one member selected from substances having oxidizability higher than that of iron, as represented by Si, Ti, Al and Cr.

5. The method for manufacturing a soft magnetic material according to any one of claim 1, wherein said weakly oxidizing gas is water vapor or a dinitrogen monoxide gas.

6. The method for manufacturing a soft magnetic material according to any one of claim 1, wherein said weakly oxidizing gas is water vapor mixed with said inert gas so that the relative humidity at an ordinary temperature can be higher than 50%.

7. The method for manufacturing a soft magnetic material according to any one of claim 1, wherein said weakly oxidizing gas is water vapor mixed with said inert gas so that the relative humidity at an ordinary temperature can be from 70 to 100%.

8. The method for manufacturing a soft magnetic material according to any one of claim 1, wherein said surface oxidizing step is preformed under the temperature condition of 400 to 600° C.

9. The method for manufacturing a soft magnetic material according to any one of claim 1, wherein said sintering step is preformed under the temperature condition of 400 to 1,100° C.

10. The method for manufacturing a soft magnetic material according to any one of claim 1, wherein said sintering step comprises a first step of re-forming said oxide film by contacting the soft magnetic powder with a weakly oxidizing gas under the temperature condition of 400 to 600° C., and a second step of sintering said soft magnetic powder under the temperature condition of 600 to 1,100° C.

11. The method for manufacturing a soft magnetic material according to any one of claim 1, wherein said soft magnetic powder is an atomized alloy powder having an average particle diameter of 0.01 to 500 μm.
